(19) United States
(12) Patent Application Publication
(10) Pub. No.: US 2011/0216263 A1
(43) Pub. Date: Sep. 8, 2011

(54) VENTED MENU DISPLAY CABINET

(76) Inventor: Michael S. Barnes, Kennesaw, GA (US)

(21) Appl. No.: 12/984,493

(22) Filed: Jan. 4, 2011

Related U.S. Application Data
(63) Continuation-in-part of application No. 11/948,986, filed on Nov. 30, 2007, now Pat. No. 7,861,990.
Application No. 11/948,986 is a continuation-in-part of application No. 11/267,617, filed on Nov. 7, 2005, now abandoned.
Application No. 11/267,617 is a continuation-in-part of application No. 11/200,464, filed on Aug. 10, 2005, now Pat. No. 7,311,290.

(51) Int. Cl. G02F 1/1333

(52) U.S. Cl. 349/58

(57) ABSTRACT

The invention relates to a display cabinet system that includes a lamp assembly that is hingedly attached to a chassis body. The chassis body is coupled to an LCD display unit and is contained within a cabinet body. A cabinet cooling system is included with the display cabinet system which includes air intake vents, air exhaust vents and air channels throughout the interior of the display cabinet. One of the air channel of the cabinet cooling system is between the LCD display unit and the lamp assembly.

### CROSS-REFERENCE TO RELATED APPLICATIONS

This application is a continuation-in-part of prior U.S. application Ser. No. 11/948,986, filed Nov. 30, 2007, which is a continuation-in-part of prior U.S. application Ser. No. 11/267,617, filed Nov. 11, 2005, which is a continuation-in-part of prior U.S. application Ser. No. 11/200,464, filed Aug. 10, 2005. Each of these references is incorporated herein by reference.

### BACKGROUND OF THE INVENTION

1. Field of the Invention

This invention is directed to the field of awning support systems, such as may be used in shading windows, doors, and the like, and more particularly to readily-mounted support systems and awning frame assembly members, where the systems may be readily handled and installed by a single installer or handyman. Additionally, the invention relates to illuminated display devices and/or LCD display devices for presentation of advertisements and promotional materials, particularly for outdoor environments.

2. Background and Related Art

Various businesses, particularly fast food restaurants, utilize outdoor signs to present advertisements, promotional materials, menu items, and specials. These signs are often lighted for nighttime view. When used outdoors, displays must be able to withstand environmental conditions, including, wind, rain, snow, sun, freezing temperatures and elevated temperatures while maintaining mechanical integrity and aesthetic value for long periods of time with minimal upkeep.

Outdoor sign devices which have an enclosed housing, protecting promotional materials often have overheating and moisture problems. These problems are exacerbated by the use of internally backlit signs or signs that utilize internal mechanical features that utilize electricity as a source of power. Electrically powered internal components create heat, increase condensation and impair functioning.

Outdoor signs also must provide security for the various internal components to avoid the internal components from being tampered with or vandalized. At the same time, display devices must allow access to the displays by authorized personnel in order to change promotional materials perform mechanical inspection and repair of items on the interior of the cabinet. While some prior art display devices require frequent access by authorized personnel, it may be desirable to provide a menu cabinet which requires little maintenance and is capable of receiving updated information, including updated menus and special items without directly accessing the display unit itself.

### BRIEF SUMMARY OF THE INVENTION

The present invention provides for a display cabinet. In embodiments, an enclosed housing encloses a display apparatus, which may comprise a lamp assembly and/or LCD display for displaying advertising and promotional materials. The enclosed housing may include various elements. For example, in some embodiments, the enclosed housing includes a cabinet cooling system for maintaining desirable temperatures inside the cabinet, a cabinet body door hingedly connected to the enclosed housing allowing for access to the internal components of the display, a thermostat control device functionally connected to the cabinet cooling system to allow for accurate measurement and control of the internal temperature of various components of the display device, power supplies, and a video control board for storing various video displays at the sign.

A channel may be provided through the interior of the display device to allow air to flow between an LCD display and other components of the display device. In this fashion, the display device may be closed and one or more vents may be provided on the back of the device in order to allow for the circulation of air effectively venting off any hot air build up inside the device. Similarly, a plurality of lights, such as vertical, horizontal, fluorescent lights positioned in the housing may provide light through an advertisement and around an LCD display in order to enhance the aesthetic quality of the display or make various constitutive elements of the display visible to the public at night. The air channel through the enclosed housing may be utilized in like fashion to allow air flow between or around the plurality of lights to provide venting of hot air buildup inside the device.

### BRIEF DESCRIPTION OF THE SEVERAL VIEWS OF THE DRAWINGS

The objects and features of the present invention will become more fully apparent from the following description and appended claims, taken in conjunction with the accompanying drawings. Understanding that these drawings depict only typical embodiments of the invention and are, therefore, not to be considered limiting of its scope, the invention will be described and explained with additional specificity and detail through the use of the accompanying drawings in which:

FIG. 1 is a perspective view of an embodiment of an awning bracket according to embodiments of the invention;

FIG. 2 is a side view of the awning bracket illustrated in FIG. 1;

FIG. 3 is a rear view of the awning bracket of FIG. 1;

FIG. 4 is a further side plan view of the awning bracket of FIG. 1, showing the bracket in a supporting relationship to an angled awning;

FIG. 5 is a cross-sectional or end view of an embodiment of a horizontal awning support member for positioning and securing to the bracket;

FIG. 6 includes a cross-sectional or end view and a side view of an embodiment of an end member, connecting block, or attachment block for snug sliding receipt in the horizontal awning support member;

FIG. 7 is a front plan view showing plural awning brackets positioned for supporting a pair of awnings;

FIG. 8 is a perspective view showing embodiments of the awning brackets and the awning support members used in conjunction with the brackets, showing mechanisms and methods for assembly of an awning in accordance with embodiments of the invention;

FIG. 9 shows a cross-sectional or end view of the embodiment of the awning support member of FIG. 5 containing the nested embodiment of the connecting block of FIG. 6, as may occur during assembly of some embodiments of the invention;

FIG. 10 illustrates a partial cutaway view of using awning support members, awning spar supports, and connecting blocks to assemble embodiments of awning frames;

FIG. 11 is a perspective view of an alternate embodiment of an awning bracket according to embodiments of the invention;

FIG. 12 is a side view of the awning bracket illustrated in FIG. 11;

FIG. 13 is a perspective view of a section of flashing for use with embodiments of the invention;

FIG. 14 is a side plan view of an assembled awning including the embodiment of the awning bracket of FIG. 11 and the embodiment of the flashing of FIG. 13;

FIG. 15 is a close-up plan view of the embodiment of FIG. 14;

FIG. 16 is a perspective view of a section of an embodiment of an awning support structure in accordance with some embodiments of the invention;

FIG. 17 is a side plan view of an assembled awning including the embodiment of the awning support structure of FIG. 16;

FIG. 18 is a close-up plan view of the embodiment of FIG. 17;

FIG. 19 is a plan view showing one method of attaching an awning skin to an awning support member;

FIG. 20 is a plan view of an alternate method of attaching an awning skin to an awning support member;

FIG. 21 is a plan view of an alternate method of attaching an awning skin to an awning support member; and

FIG. 22 is a plan view showing one method of attaching an awning support member to an awning bracket.

FIG. 23 provides a top, front, side and back view of an LCD menu cabinet in accordance with an embodiment of the present invention;

FIG. 24 is a top sectional view, a top view assembly and a cutaway view of hinged elements of an LCD menu cabinet in accordance with an embodiment of the present invention;

FIG. 25 provides a sectional view at the cabinet's center, a lamp assembly door panel view, a rear, a top sectional view and a chassis door panel view at rear in accordance with an embodiment of the present invention;

FIG. 26 illustrates a side cutaway view and a front view of an LCD menu display and a display flip frame in accordance with an embodiment of the present invention;

FIG. 27 illustrates a hinge in closed and open position in accordance with an embodiment of the present invention;

FIG. 28 illustrates a side cutaway view of both double face cabinet extrusions and single face cabinet extrusions in accordance with an embodiment of the present invention;

FIG. 29 illustrates a perspective view of an illuminated display device in accordance with an embodiment of the present invention; and

FIG. 30 illustrates a front view, section side view and two section side views of an illuminated menu box in accordance with an embodiment of the present invention.

### DETAILED DESCRIPTION OF THE INVENTION

A description of embodiments of the present invention will now be given with reference to the Figures. It is expected that the present invention may take many other forms and shapes, hence the following disclosure is intended to be illustrative and not limiting, and the scope of the invention should be determined by reference to the appended claims.

Embodiments of the invention are directed to awning and light support systems, and kits of components, of the type to provide sun and rain protection to a window or door of a structure. More particularly some embodiments of the invention relate to an easily-installed system that includes a pair of uniquely constructed L-shaped bracket members for mounting to the respective sides of the window or door. Alternate embodiments of the invention relate to an easily-installed system that includes a nested support structure and awning projection props. Embodiments of the invention also utilize a new frame assembly system. The details of the various systems will become clearer in the following description and accompanying drawings, where like reference numerals represent like components or features throughout the several views.

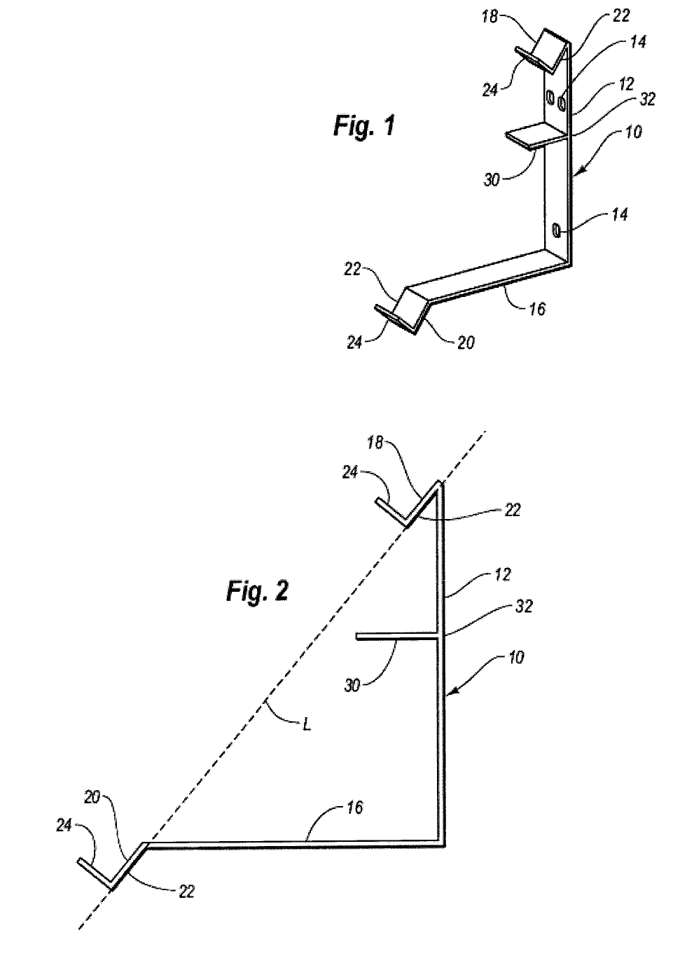

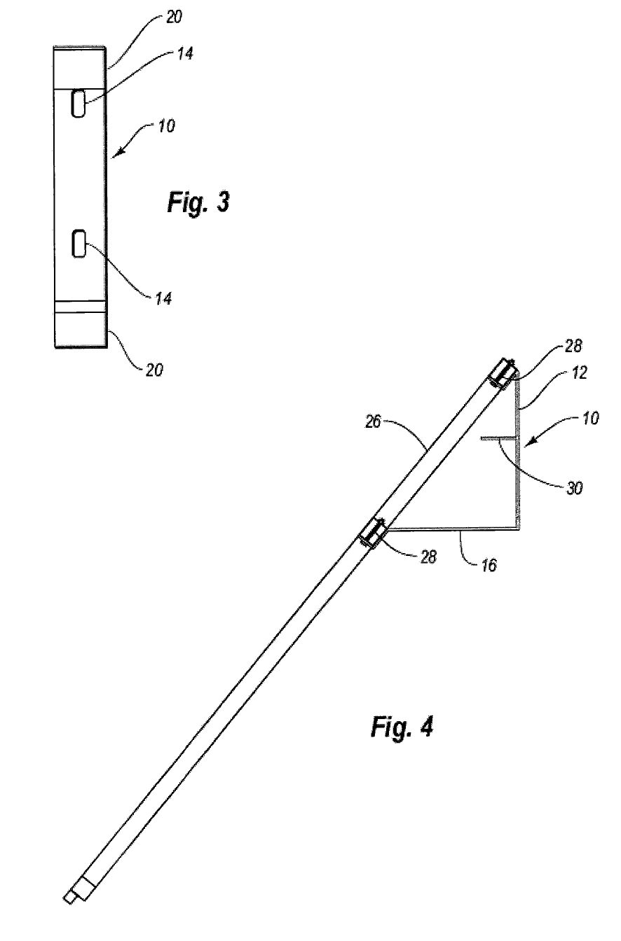

Turning now to FIGS. 1-4, illustrating different views of a uniquely constructed bracket member of this invention, FIG. 1 shows an L-shaped bracket member 10. The bracket member 10, one of a pair of brackets that may be removably secured at the respective sides of a window or door, comprises a vertically-oriented leg 12, containing plural fastener-receiving apertures 14 for mounting such leg 12 proximate to a structure by lag bolts or other suitable fasteners as known in the art. Joined to and perpendicular thereto is a horizontally-oriented leg 16.

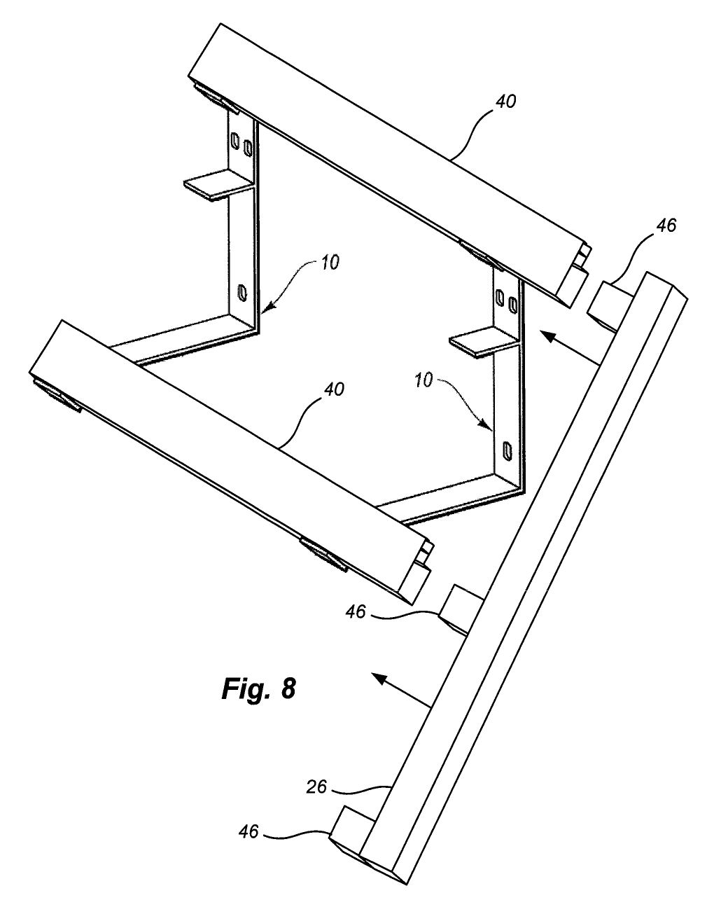

The respective free ends 18, 20, of the bracket member legs 12, 16, may be L-shaped configurations having first downwardly-angled arms 22, in a common alignment illustrated by the theoretical line L, terminating in perpendicular arms 24. As best seen in FIG. 4 and FIG. 8 said free ends 18, 20 are used to secure awning support members 40 and an awning spar support 26 through fastener members 28. The awning spar support 26 and the support members 40 may be extruded aluminum. By the use of a pair of such bracket members 10, a single person can easily install the awning over a selected window or door. Additionally, as seen in FIG. 7, additional such bracket members 10 may be used to support an easily-installed awning over a wider window/door or over a plurality of windows and/or doors.

Further, to provide lighting to the underside of the awning, the vertically-oriented leg 12 is provided with an inwardly-directed leg 30, essentially parallel to said horizontally-oriented leg 16, from a midpoint 32 of the leg 12, where the inwardly directed leg 30 does not extend to the theoretical line L illustrating the alignment of downwardly-angled arms 22. Inwardly-directed legs 30 provide a means of mounting a light fixture, as is known in the art.

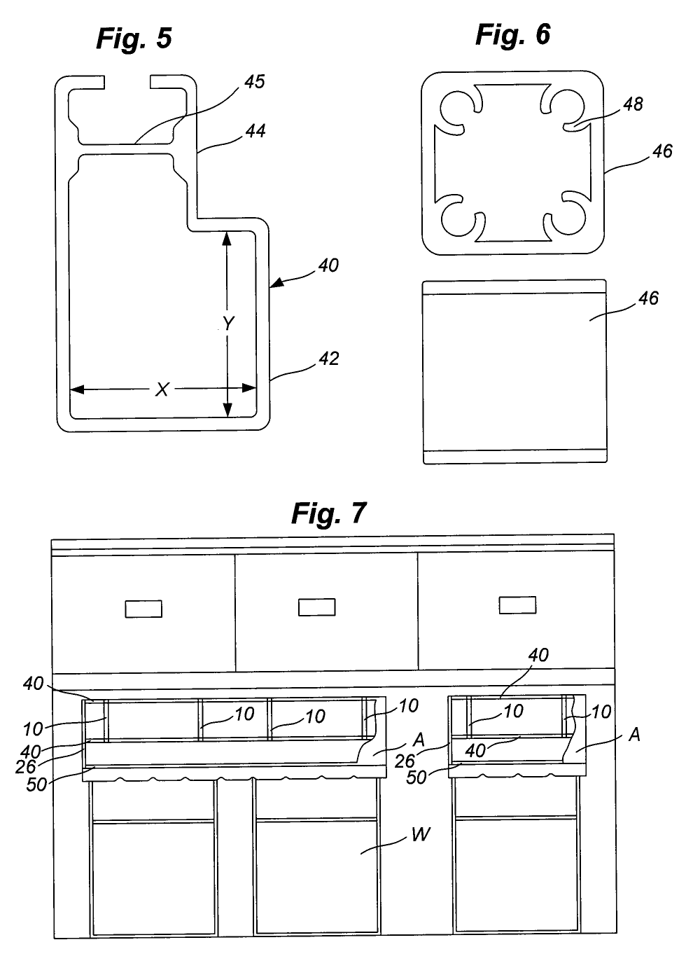

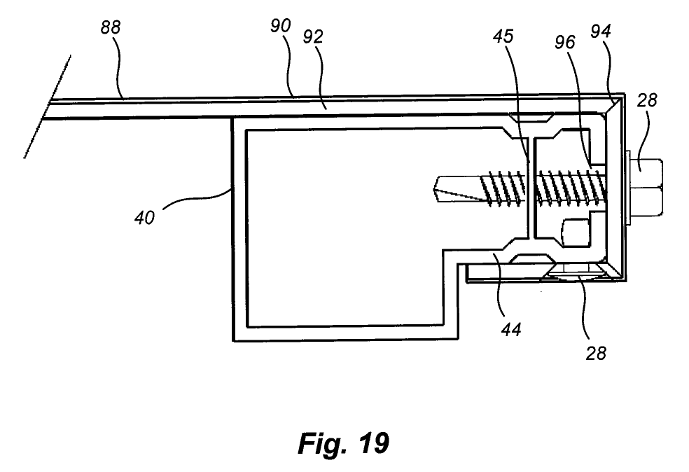

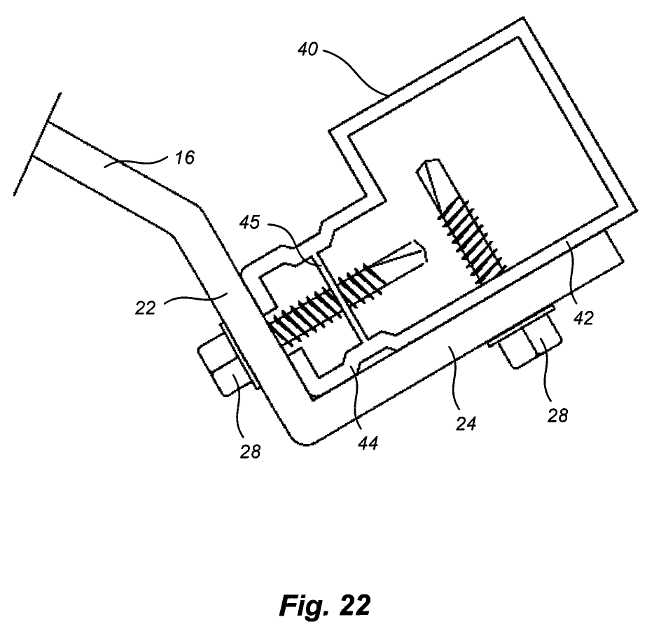

FIG. 5 shows an end or cross-sectional view of a horizontally-disposed awning support member 40, and FIG. 6 shows both an end or cross-sectional view and a side view of one embodiment of a horizontally-disposed connecting block 46. The first said awning support member 40, FIG. 5, may comprise an aluminum extrusion of a length to extend at least the width of a window, see FIG. 7, having a first leg 42 with internal dimensions “X” and “Y,” and may have a second smaller leg 44 extending therefrom, where the second smaller leg 44 may include a cross support rib 45. In some embodiments, the dimensions “X” and “Y” may be approximately equal. In embodiments where the second smaller leg 44 is present, the second smaller leg 44 may be used to receive a metal-piercing staple or other fastener to affix the awning material, skin, or cover (such as fabric or vinyl) to the awning frame, as will be illustrated later with respect to FIGS. 19-21, and may also be used to receive one or more fasteners to attach the awning support member 40 to the bracket member 10 or other support, as will be illustrated later with respect to FIG. 22.

The awning support member 40, and more specifically the first leg 42, is sized to seat within the bracket free ends 18, 20, one for the top and one for the bottom of the bracket member 10 with the awning support member 40 in any desired rotational orientation (i.e. with the second smaller leg 44 up or down). The connecting block 46, FIG. 6, may also comprise an aluminum extrusion and may be generally rectangular in cross-section having a width approximately equal to or slightly less than “X” and a height approximately equal to or slightly less than “Y,” whereby it may be slidably and snugly received within said first leg 42 of said awning support member 40. The length of the connecting block 46 may be limited to a length sufficient to be secured within said first leg 42 and optionally may be extended to a length sufficient (potentially significantly longer than the length illustrated in FIG. 6) to also permit securing of said arms 22, 24 at said free ends 18, 20 to said connecting block 46 within said first leg 42 of said awning support member 40. Note that the connecting block 46 may include plural, arcuate arms 48 to define several screw bosses for securing the assembled first and second awning support members 40, 46 to the awning spar support 26, as will be described in more detail below.

Connecting block 46 provides means for securing the awning support members 40, the connecting block 46, and/or the awning spar support 26 to another extrusion member 50 (such as along the bottom edge of the awning) and/or to brackets 10. By mounting and securing a pair of the assembled awning support members 40 and connecting blocks 46 to a pair of said L-shaped brackets 10, support for the awning is firmly secured about its top and sides. Support for the awning may be further secured about its bottom edge by the further extrusion member 50 that may be similar in cross-section to the awning support member 40, or may have a square or rectangular cross-section with internal dimensions equal to “X” and “Y,” as will be further appreciated below. The awning, along its upper and lower ends and along its mid section, may be stapled by metal piercing staples or other fastening members, as is known in the art.

FIG. 7 illustrates how the system of this invention may be mounted above a single or pair of doors and/or windows “W.” FIG. 7 illustrates a plan view of assembled awnings, in which the awning material or awning skin, “A,” has been partially cut away to show the frame members and bracket members 10 of the awning. The bracket members 10 may be attached to the building's wall either above or to the side of the window(s) and/or doors. Awning support members 40 are received by and attached to the free ends 18, 20 of two or more bracket members 10, with the awning support members 40 in a generally-horizontal position. As may be appreciated by one of skill in the art, the awning support members 40 may be sized to match a desired awning width on site, such as by cutting the awning support members 40 to length.

In FIG. 7, the rightmost awning is supported by two bracket members 10, while the leftmost awning, which spans two windows, is supported by four bracket members 10. Those of skill in the art will readily appreciate that any number of bracket members 10 may be used depending on the horizontal space to be spanned. The awning support members 40 may be located on the free ends 18, 20 in any desired rotational orientation. In addition, as set forth above, the cross-sectional shape of the awning support members 40 may be varied and still fall within the scope of the embodiments of the invention. It is anticipated that the cross-sectional shapes of the awning support members 40 may be approximately square, approximately rectangular, or any other shape that fulfils structural and/or aesthetic purposes. In other words, in some embodiments, the cross-sectional shapes of the awning support members 40 may include the first leg 42 without any corresponding second leg 44.

An awning spar support 26 is attached at either end of the awning support members 40, using the connecting blocks 46, as is illustrated in FIGS. 8-10. FIG. 8 illustrates a perspective view of a pair of bracket members 10 as illustrated in FIG. 1, with a pair of horizontally-disposed awning support members 40 in the free ends 18, 20 of the bracket members 10. The elements illustrated in FIG. 8 are not to scale, but FIG. 8 is intended merely illustrate the principles of assembly and functions of the elements of embodiments of the invention. As may be appreciated from FIG. 8, the downwardly-angled arms 22 and the perpendicular arms 24 serve to easily align and locate the awning support members 40 during assembly of the awning. In FIG. 8, three connecting blocks 46 have been attached to the awning spar support 26. Two connecting blocks 46 have been attached at locations corresponding to the awning support members 40 (one near the top of the awning spar support 26, and one near the center of the awning spar support 26), and a third connecting block 46 has been attached near the lower end of the awning spar support, to provide a connection for the extrusion member 50 that serves to anchor the lower end of the awning. The exact placement of the connecting blocks 46 may be varied and still fall within the scope of the embodiments of the invention; for example, the placement may be varied to provide a bigger or smaller awning (i.e. one that extends farther from or less far from the building, structure, or wall to which the awning is attached).

The connecting blocks 46 may be secured to the awning spar support 26 by any means of securing known in the art, including fasteners such as self-tapping screws (a subset of fastener members 28) through the screw bosses formed by the arcuate arms 48. Once the connecting blocks 46 are secured to the awning spar support 26, the awning spar support 26 may be moved in the direction of the arrows in FIG. 8 relative to the awning support members 40 until the connecting blocks 46 enter into the awning support members 40. At that time, additional means for securing, such as self-tapping screws or other fastener members 28 may be used to permanently or reversibly secure the awning support members 40 to the connecting blocks 46, and thus to the awning spar support 26, as illustrated in FIG. 7. Assembly of the additional extrusion member 50 at the lower edge of the awning, and then a corresponding awning spar support 26 at the other end of the awning occurs similarly, as may be appreciated by one of skill in the art. As will also be appreciated by one of skill in the art, the length of the connecting block 46 may be lengthened, or the bracket members 10 may be disposed close to the awning spar support 26 to permit securing of the bracket members 10 to the connecting block 46 through the awning support members 40. Alternatively, the bracket members 10 may be secured to the awning support members 40 without being secured to the connecting blocks 46.

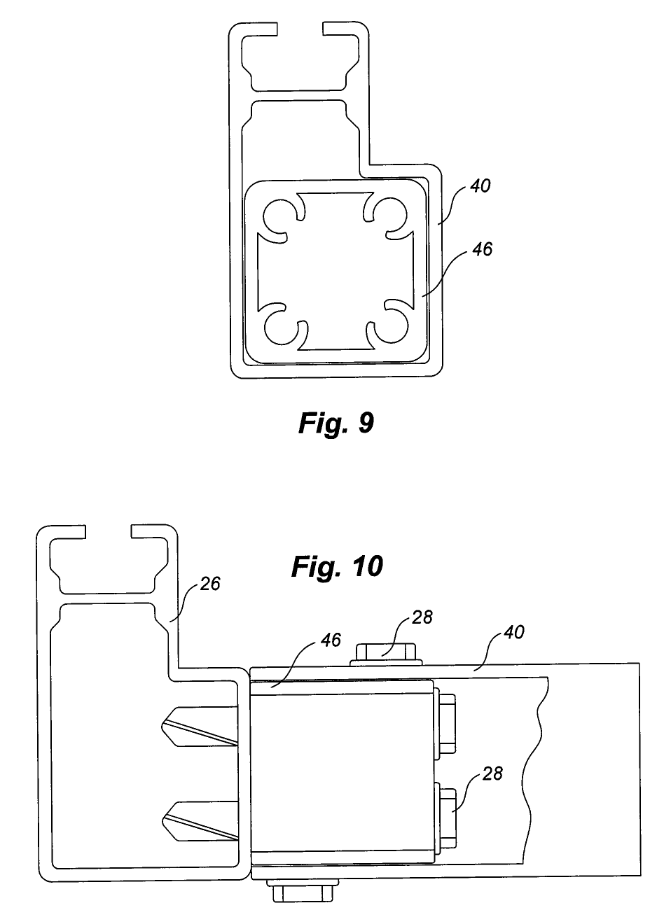

FIG. 9 illustrates one example of how the connecting block 46 is received into the end of the awning support member 40 (or, similarly, how the connecting block 46 is received into the additional extrusion member 50). FIG. 10 shows a detailed view of an example of the final connection between the various members of the awning support frame (not including the bracket members 10). The connecting block 46 is secured to the awning spar support 26 by fastener member(s) 28. The connecting block 46 is then received within the end of the awning support member 40 (or alternatively the extrusion member 50) as illustrated in FIGS. 8-9, and is secured by additional fastener member(s) 28, which may include screws, self-tapping screws, bolts and nuts, and/or rivets.

When the awning frame is assembled as depicted in FIG. 7, the awning skin material (“A”) may be attached to the frame as illustrated in FIG. 7. The awning skin material may be any desired awning material known in the art or later invented, including cloth, aluminum, composites, and laminate materials. Additionally, the awning skin may comprise an additional frame and material, and may comprise a pre-assembled frame and material for mounting to the fully-assembled awning frame. If desired, sides may also be provided for the awning, and may be provided as integral members of the awning spar supports 26, or may alternatively be attached separately to the awning spar supports 26 and/or to the building, such as by fastener member(s) 28. In embodiments where the awning spans a large space, such as multiple windows, additional awning spar supports 26 may be located along the span for additional support (i.e. such as between the two windows of the leftmost awning illustrated in FIG. 7). In such embodiments, the connection between frame elements may be provided by attaching connecting blocks 46 to both sides of the intermediate awning spar supports 26, as will be appreciated by those skilled in the art.

As may be appreciated from the above description, assembly and disassembly of the awning may be readily accomplished on-site by a single handyman or installer with standard tools. As illustrated in FIGS. 8-10, the bracket members 10 may be mounted to the structure or building to receive the awning, the awning support members 40 may be rested in or attached to the bracket members, and the remaining portions of the awning frame may be assembled to the awning support members 40, as described. The awning skin may then be attached, along with any additional structures, such as awning sides. The reverse process may then be followed to disassemble the awning.

Alternatively, the awning frame may be assembled as described above, but on a flat horizontal surface to make assembly of the frame easier. The awning skin may also be attached to the frame at this stage. The entire assembled frame (and awning skin, if applicable) may then be lifted onto the mounted bracket members 10, and then attached to the bracket members 10, such as by fastener members 28. In still another example of a possible assembly sequence, the frame may be assembled and attached to the bracket members 10 on the ground, and the entire awning may then be lifted up and attached to the structure at the bracket members 10. Thus, it may be seen that the structure of the embodiments of the invention provide ease and flexibility of assembly of an awning. As set forth above and as will be appreciated by one of skill in the art, in some embodiments the awning support members 40, additional extrusion member(s) 50, the awning skin, and even the awning spar supports 26 may be cut to size/length on site to accommodate a smaller awning than the maximum size contemplated by the kit of components.

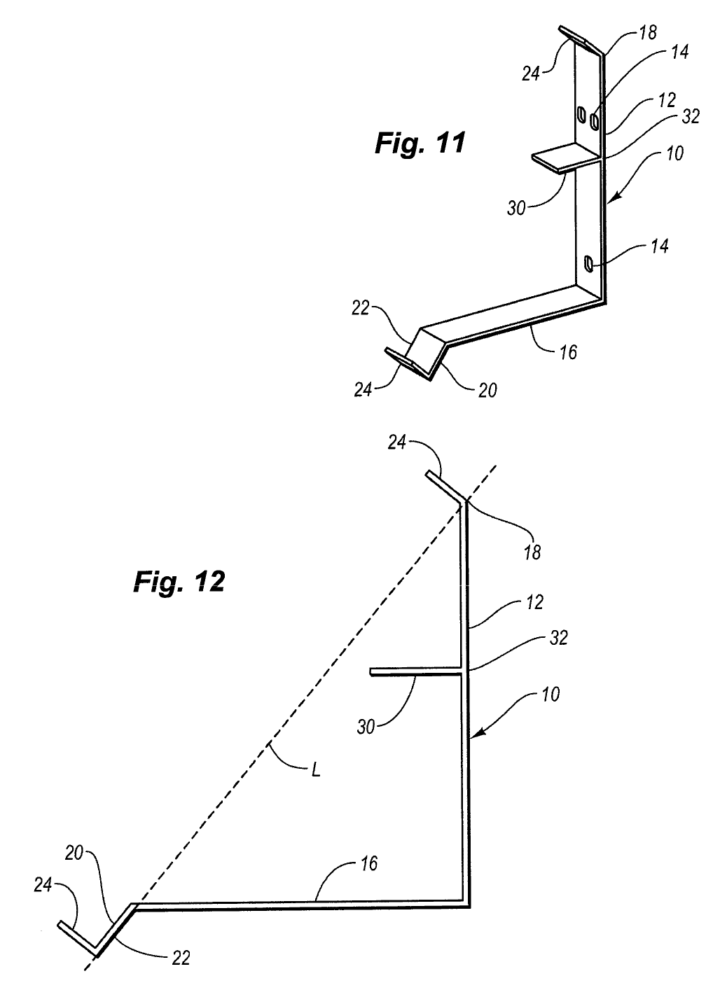

FIGS. 11 and 12 depict an alternate embodiment of the bracket members 10 that may be used with embodiments of the present invention. In the illustrated embodiment, the free end 18 of the vertically-oriented leg 12 does not include a downwardly-angled arm 22. Instead, the perpendicular arm 24 extends directly from the free end 18 of the vertically-oriented leg 12. In this embodiment, the perpendicular arm 24 attached to the vertically-oriented leg 12 is still substantially perpendicular to the theoretical line “L,” as is the perpendicular arm 24 of the horizontally-oriented leg 16 (compare FIGS. 2 and 12), and the arrangement of the other parts of the awning frame is substantially similar to that described above. In still other alternate embodiments, the perpendicular arm 24 may be directly attached to the horizontally-oriented leg 12 without a downwardly-angled arm in addition to or alternatively to the perpendicular arm 24 being directly attached to the vertically-oriented leg. In still other embodiments, one or more of the perpendicular arms 24 may be omitted and the awning support members may be secured directly to the downwardly-angled arm(s).

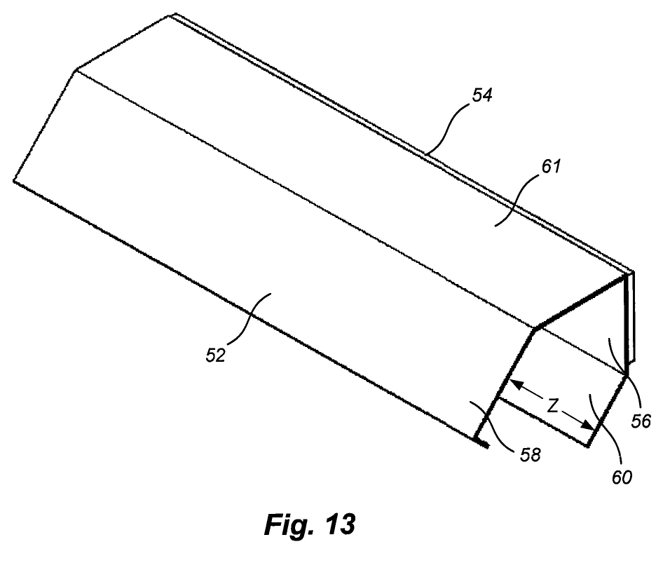

In some embodiments of the invention, a flashing may be provided to reduce or prevent moisture from passing behind the top of the awning, as illustrated in FIGS. 13-15.

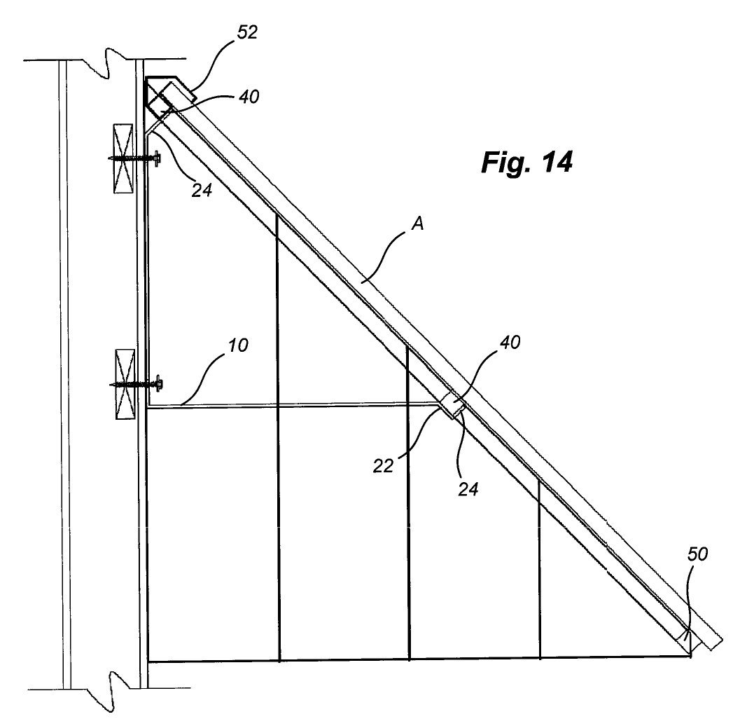

FIG. 13 illustrates an embodiment of such a flashing 52. The flashing 52 may include weather stripping 54 to be disposed against the wall of the building, to seal the awning against the wall and prevent the entry of moisture behind the awning next to the building. FIG. 14 illustrates a side plan view of an assembled awning according to the embodiment of the bracket member 10 illustrated in FIGS. 11-12, including the flashing 52 illustrated in FIG. 13. In the illustrated embodiment, the awning support members 40 and the additional extrusion member 50 have an approximately-square cross-section.

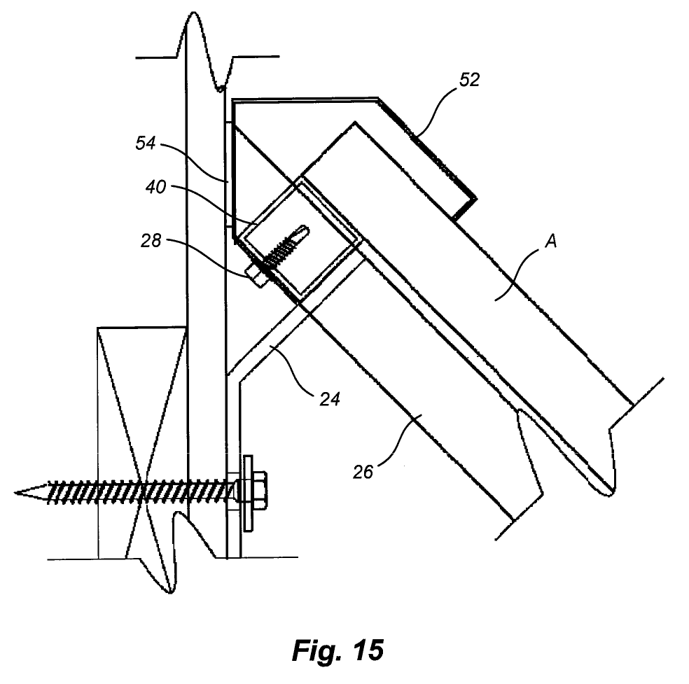

FIG. 15 shows a close-up view of the embodiment of FIG. 14, better showing the function of the flashing 52 in sealing the top of the awning. As is seen in FIG. 15, the flashing 52 may be attached to the uppermost awning support member 40 by fastener members 28. The flashing 52 may be of a substantially-rigid material, such as aluminum, and may therefore be secured to the upper awning support member 40 by fastener members 28 having a spacing of several inches to several feet, as the flashing is not typically exposed to strong forces.

As is shown in FIG. 13-15, the flashing 52 includes a substantially-vertical portion 56 that conforms to the wall or structure to which the awning is mounted, and which secures the weather stripping 54, if present. The flashing 52 also includes front angled portion 58 and back angled portion 60, which are separated by a distance “Z” that may correspond to the thickness of the awning frame (i.e. awning support member 40) and awning skin, as illustrated in FIGS. 14 and 15. This distance “Z” prevents wind-blown rain or snow from passing up under the flashing 52, as the front edge of the flashing 52 rests close to or adjacent the awning skin when the back angled portion 60 is secured to the upper awning support member 40. The flashing 52 may also include a substantially-horizontal portion 61, as illustrated in FIGS. 13-15, or the vertical portion 56 and the front angled portion 58 may be extended vertically to meet each other for aesthetic or other reasons. The horizontal portion 61 may also be replaced with an additional angled portion having an angle different than the front angled portion 58, for aesthetic or other purposes.

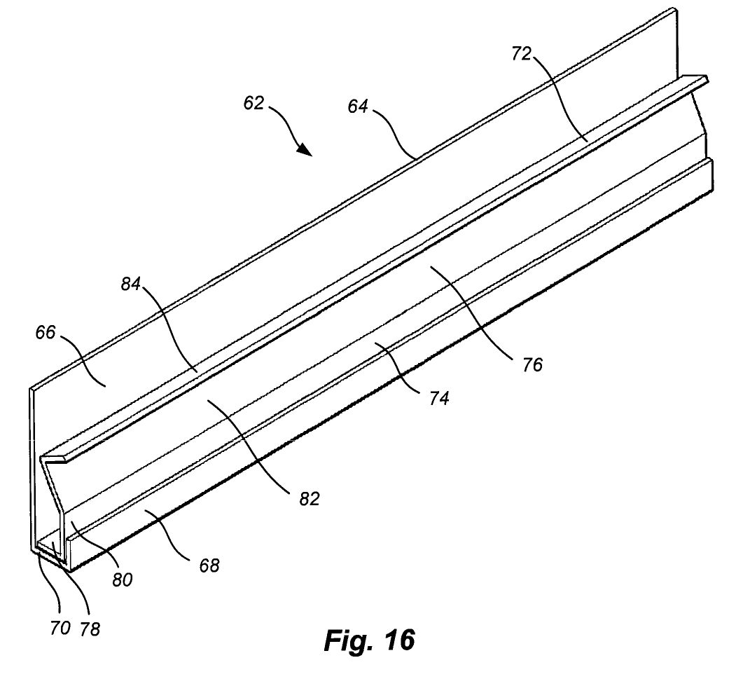

In some embodiments of the invention, the moisture-stopping functions of the flashing 52 and the weight-bearing support functions of the bracket members 10 may be combined, as is illustrated in FIGS. 16-18. In these embodiments, the awning frame (including awning support member(s), additional extrusion member(s), awning spar supports 26, and connecting blocks 46) may be assembled in similar fashion to that described above with regards to FIGS. 5-10, with the bracket members 10 being omitted and replaced as described below.

FIG. 16 shows a support structure 62 that supports the weight of an awning and also provides for dispersal of water to the sides of the awning, including water running down a wall or other structure from above the awning. The support structure 62 includes a support channel 64 that may be mounted directly to a wall. The support channel 64 may have a “U” shape or cross-section, with one arm of the “U” shape partially truncated, as may be seen in FIG. 16. A higher arm 66 of the “U” shape provides a surface to receive fasteners such as fastener members 28 (which may be lag bolts or other fasteners, as is known in the art) for mounting the support structure 62 to the wall. A lower arm 68 prevents water entering the channel formed by the higher arm 66, the lower arm 68, and a horizontal arm 70 connecting the higher arm 66 and the lower arm 68 from flowing forward and under the awning. Thus, water that enters the channel from above is directed to the sides of the awning by the support channel 64.

The support channel 64 may receive an awning mounting member 72 that is configured to be mounted to the awning frame and to rest in and be attached to the support channel 64. The support channel 64 and the awning mounting member 72 form the support structure 62. The support channel 64 and the awning mounting member 72 may be of any material known in the art to have sufficient strength and durability to perform the functions recited herein, including aluminum, whether extruded aluminum or bent or formed sheet aluminum, stainless or painted steel, and other painted or unpainted metals and alloys. In some instances, plastics or plastic-coated metals may be used for the support channel 64 and the awning mounting member 72.

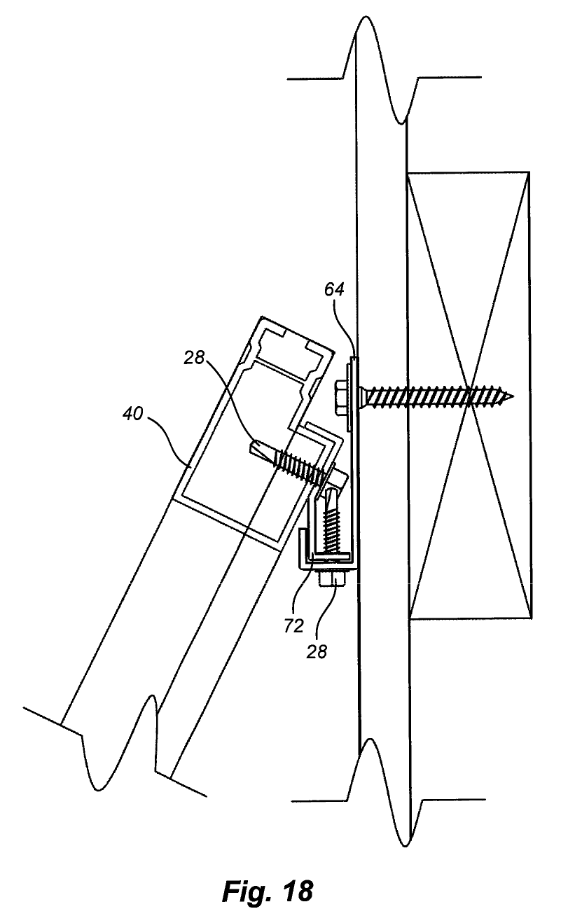

The awning mounting member 72 may include a first portion 74 configured to mate with, rest in, and be mounted to the support channel 64. In the embodiment illustrated in FIG. 16, the first portion 74 includes a substantially-horizontal portion 78 that rests on the horizontal arm 70 and a substantially-vertical portion 80 that generally touches and rests against the interior side of the lower arm 68. The first portion 74 may be sized so as to be snugly secured in the support channel 64, as illustrated in FIGS. 16 and 18.

As may be appreciated by reference to FIG. 18, the horizontal arm 70 and the horizontal portion 78 provide a mechanism whereby the support channel 64 and the awning mounting member 72 may be connected together. For example, these structures may be connected together by any means known in the art, including adhesives and fasteners. By way of example and illustration, FIG. 18 shows the connection being made by way of fastener members 28. To aid in the water-dispersing function of the support channel 64, a sealant such as weather stripping may be disposed between the support channel 64 and the first portion 74 of the awning mounting member 72, effectively increasing the water-conducting volume of the support channel 64, as will be appreciated by one of skill in the art.

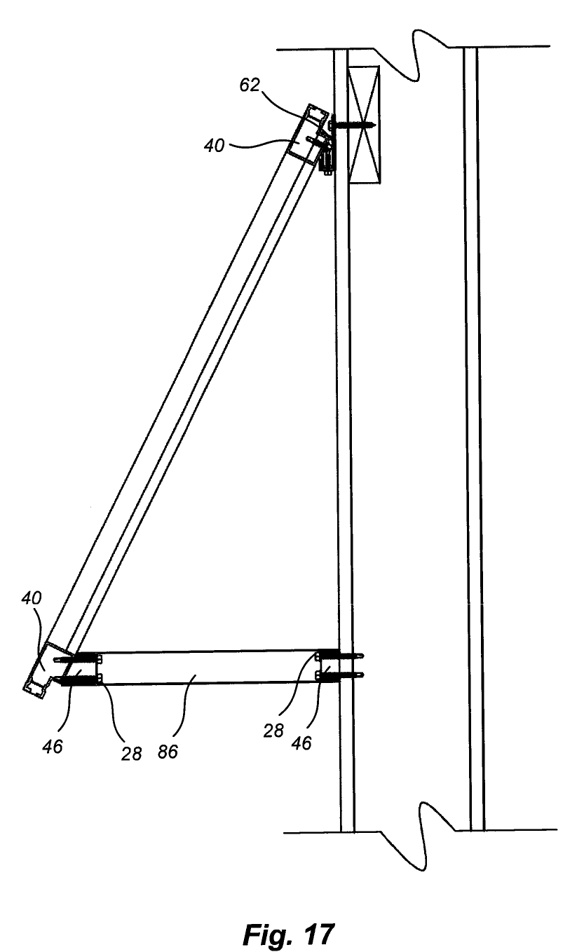

The awning mounting member 72 also includes an awning-connecting portion 76 configured to attach to the frame of the awning, as illustrated in FIGS. 17 and 18. Although the awning-connecting portion 76 may take any desired shape so as to mate with the awning frame, FIGS. 16-18 show an embodiment having a first angled portion 82 and a second angled portion 84. The first angled portion 82 and the second angled portion 84 conform to the shape of the awning frame, as illustrated best in FIG. 18, and provide surfaces and structures for connecting the awning mounting member 72 to the awning frame (i.e. the upper awning support member 40), such as by fastener members 28. As may be appreciated by one of skill in the art, one or more surfaces of the support channel 64 and/or the awning mounting member 72 may be provided with weather stripping, some other sealant, or any other means known in the art for sealing the awning to the awning mounting member 72, the awning mounting member 72 to the support channel 64, and the support channel 64 to the structure supporting the awning, to prevent water leakage. In addition, as may be appreciated by one of skill in the art, the awning mounting member 72 may be further extended to surround the top portion of the awning frame, in the manner of the flashing 52 illustrated in FIGS. 13-15.

The support structure 62 may support the bulk of the weight of the mounted awning, but as will be appreciated by one of skill in the art, the support structure 62 generally provides only minimal support for keeping the lower portion of the awning away from the building or other structure to which the awning is mounted (i.e. keeping the awning at the proper angle). Therefore, in embodiments where the support structure 62 is used, one or more awning projection props 86 may be used at a midpoint or lower portion of the awning frame, as illustrated in FIG. 17, at a location corresponding to an awning support member 40 or other extrusion member 50, or to a location somewhere along the awning spar support 26.

The awning projection prop 86 may be an extruded aluminum member of any cross-sectional shape, and may be attached to the wall and to the frame of the awning in similar manner to that discussed above with respect to FIGS. 8-10. Thus, a connecting block 46 may be attached to the wall and to the frame element (awning support member 40, additional extrusion member 50, or awning spar support 26) using fastening means such as fastener members 28. If necessary, one or both connecting blocks 46 may be formed or cut on an angle corresponding to the angle of incidence between the awning projection prop 86 and the wall or frame element, as will be appreciated by one of skill in the art. The awning projection prop 86 may then receive the connecting blocks 46 in either end and be secured to the connecting blocks 46 by further fastener members 28 or other fastening means, such as rivets, as described above in detail. In some embodiments, the awning projection props 86 may be incorporated into or formed with a side of the awning, or may be replaced by an awning side that is sufficiently rigid to perform the functions of the awning projection props 86.

As will be appreciated from the above discussion, assembly of such embodiments of the invention is also readily performed on site by a handyman or single installer using standard tools. The awning frame may be assembled in the manner discussed above with respect to FIGS. 8-10, with assembly occurring on a flat horizontal surface, such as on the ground. The awning mounting member 72 and connecting blocks 46 for the awning projection props 86 may then be mounted to the awning frame, along with the awning skin and any awning sides, if desired. The support channel 64 and the building-side connecting blocks 46 may then be attached to the building at the desired locations, and the assembled awning frame may be lifted up until the awning mounting member rests within the support channel 64. The bottom of the awning may then be lifted away from the building as the awning projection props 86 (or other elements performing the function of the projection props 86) are placed to receive and engage the connecting blocks 46 and then the fastener members 28 or other fastening means may be used to secure all connections. Disassembly easily occurs by reversing the process.

Alternatively, the awning support members 40 may be assembled to the support structure 62 and the awning projection props 86 and mounted to the building, and the awning spar supports 26 may then be attached, as per FIGS. 8-10, in situ. The awning skin and any additional structure such as awning sides may then be attached as described above to complete the awning on the building. Thus, in this and similar manners, the described embodiments permit simple, quick, and effective installation of an awning by a handyman or other moderately-skilled person using standard tools.

FIGS. 19-22 provide illustrations of mechanisms of attachment of the awning skin to an illustrated embodiment of the awning support member 40 and of the illustrated embodiment of the awning support member 40 to the downwardly-angled arm 22 and perpendicular arm 24 of the bracket member 10. The illustrations are by way of example only, and one of skill in the art will readily appreciate that other shapes of the awning support member 40 may be used along with other awning skins and attachment mechanisms, and still fall within the scope of the embodiments of the invention, as contained in the appended claims.

FIG. 19 illustrates one method of attaching a composite awning skin 88 to the awning support member 40. As may be appreciated from the above discussion, the awning support member may be mounted to other frame members and/or to support structures on or off of the structure wall prior to or after the awning skin such as the composite awning skin 88 illustrated in FIG. 19 is attached to the awning support member 40. The composite awning skin 88 is illustrated as having two layers, an outer layer 90 and an inner layer 92. In some embodiments, the outer layer 90 may be aluminum, copper, stainless steel, or other metals or alloys, and the inner layer 92 may be plastic such as polyethylene or fluoropolymer resins such as Lumiflon® utilized by Mitsubishi Chemical Functional Products, Inc, one manufacturer of composite awning skins 88, which manufactures Alpolic®-brand composite materials. One of skill in the art will readily recognize the great number of two-layer, three-layer, and other multi-layer composite materials that may be used in embodiments of the invention for the awning skin, including the various Alpolic® materials available.

The composite awning skin 88 may be attached to the smaller leg 44 of the awning support member 40 using fastener members 28, as is illustrated in FIG. 19. To facilitate such attachment, one or more layers of the composite awning skin 88 may be routed out at, for example, 45-degree angles to provide routed corner bends 94 to contour the composite awning skin 88 to the contours of the awning support member 40. In the illustrated embodiment, one fastener member 28, illustrated as a self-tapping screw, passes through the composite awning skin 88 and an opening 96 in the smaller leg 44 to engage the cross support rib 45. The second fastener member 28, illustrated as a rivet, which may be an aluminum rivet to resist corrosion, may be countersunk into the composite awning skin 88 and attached to a side of the smaller leg 44. In this manner, the composite awning skin 88 is securely attached to the awning support member 40, or other frame member. As discussed above, the awning spar support 26 and the additional extrusion member 50 may have similar cross-sectional profiles to the awning support member 40.

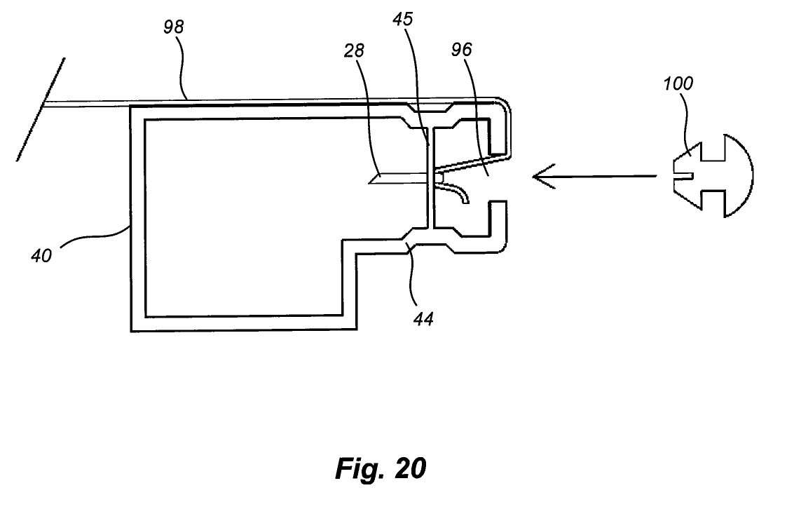

FIG. 20 illustrates one method of attaching a vinyl or fabric awning skin 98 to the awning support member 40. The vinyl or fabric awning skin 98 may be stretched over the awning support member 40 (whether fully assembled as part of an awning frame or not), and a fastener member 28 may be used to secure the vinyl or fabric awning skin 98 to the awning support member 40. By way of example, the fastener member 28 may be a metal-piercing staple that is affixed to the cross support rib 45 of the smaller leg 44, in the manner illustrated in FIG. 20. An elongated trip cap 100 may then be inserted into the opening 96, thus hiding the attachment of the awning skin 98 to the awning support member 40 (or other awning frame element).

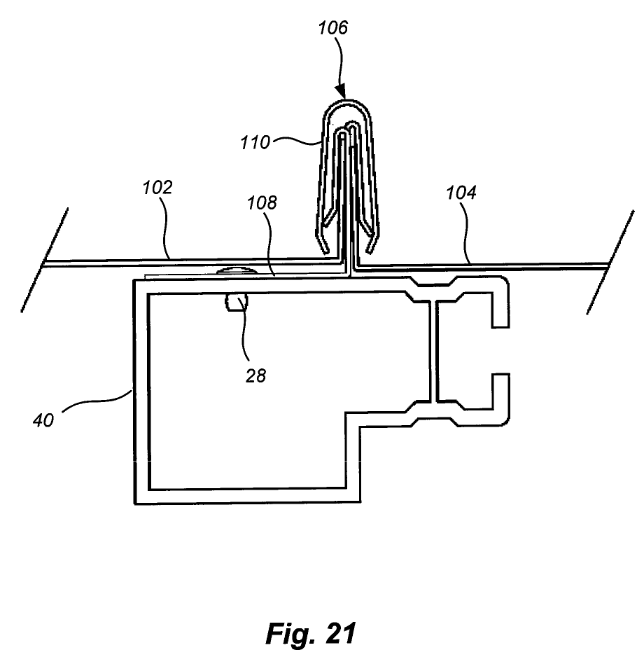

FIG. 21 illustrates one method of attaching an aluminum awning skin 102 to the awning support member 40. In alternate embodiments, the aluminum awning skin 102 may be replaced with other metals such as copper, stainless steel, or alloys, and may be painted or non-painted. In addition, FIG. 21 illustrates a mechanism for simultaneously joining the aluminum awning skin 102 (or other metal skin) to an aluminum roof panel 104 (or other metal roof panel) at a standing seam 106 using a standing seam fastener clip 108 and a batten cap. The standing seam fastener clip 108 may be attached to the awning support member 40 (or other awning frame element) using a fastener member 28 (illustrated in FIG. 21 as being a rivet, such as an aluminum rivet). The standing seam fastener clip 108 receives the end of the aluminum awning skin 102 and the end of the aluminum roof panel 104 in a vertically-oriented fashion, as illustrated in FIG. 21, and then the batten cap 110 is placed over the joint to finish the standing seam 106. One of skill in the art will readily appreciate that the awning support member 40 may be rotated any desired amount about the fastener member 28, such as forty-five or ninety degrees, to achieve an angled standing seam 106 at a desired angle other than that illustrated in FIG. 21.

FIG. 22 illustrates one orientation in which the awning support member 40 may be attached to the downwardly-angled arms 22 and the perpendicular arms 24 of one of the free ends 18, 20, of the bracket member 10. By way of example, the illustration of FIG. 22 may be in the free end 20 of the horizontally-oriented leg 16. If the awning support member 40 is in the center of the awning, the structure provided by the smaller leg 44 may not be utilized for attaching an awning skin. The awning support member 40 may be oriented as shown, and the smaller leg 44 may be used to provide an additional attachment between the bracket member 10 and the awning support member 40, as shown in FIG. 22. In FIG. 22, one fastener member 28 passes through the perpendicular arm 24 into the first leg 42 of the awning support member, and the other fastener member 28 passes through the downwardly-angled arm 22, through the opening 96 and into the cross support rib 45 of the smaller leg 44. As set forth above, the rotational orientations of the awning support member 40 shown in FIGS. 8 and 22 are merely illustrative of the potential orientations, and other rotations may be used and still fall within the embodiments of the invention.

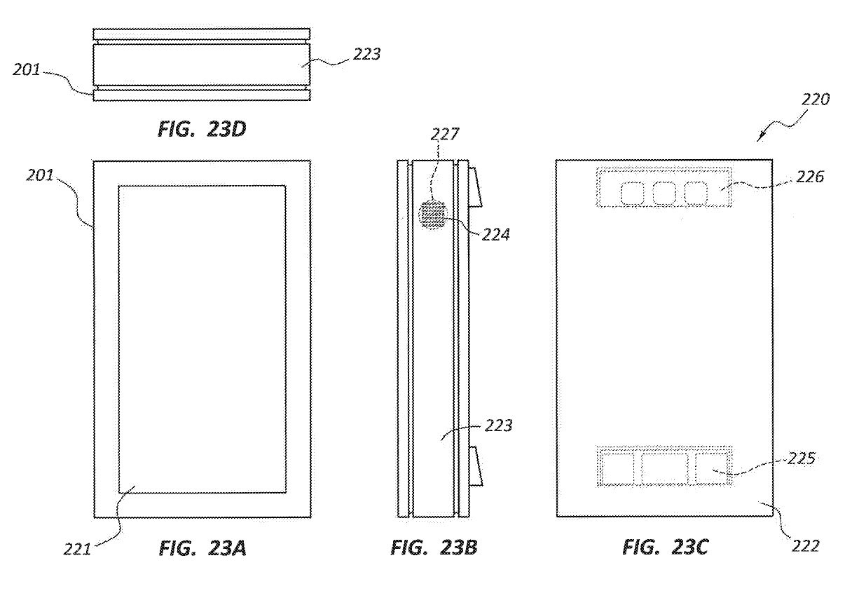

Embodiments of some additional aspects of the invention are depicted in FIGS. 23-30. FIG. 23 illustrates some basic exterior views of a display cabinet 220 according to an embodiment of the invention. The LCD menu cabinet 220 can comprise a front display side 221, a rear access panel 222 and at least two side members 223. In some embodiments, the from display side 221 comprises a rectangular-frame front door 232 that supports the outer portions of an LCD screen 204 while having an opening equal to or larger than the screen portion of the LCD screen 204. Some embodiments comprise a cabinet cooling system 205, including an internal fan unit 227 requiring exterior venting through either side members 223 or the rear access panel 222. As shown, the cabinet 200 can be substantially rectangular, to accommodate a rectangular LCD screen. In other embodiments, the cabinet 220 is square, circular, or has other shapes that are suitable for display units.

As depicted in FIG. 23, embodiments of a cabinet 220 may comprise exterior vents on side members 223 and utilize air intake vents 225 and 224 as well as air exhaust vents 226 on the rear access panel 222, to allow air to be drawn into the LCD menu cabinet 220 through the cabinet by a cooling fan 227 and out of air exhaust vents 226. As shown, some air intake vents can comprise larger holes 225 or openings in the cabinet 220, while other air intake vents can comprise screened openings or a set of small holes. In some instances, a cabinet cooling fan 227 is located inside the cabinet 220 or disposed on the exterior depending upon application.

The air intake vent(s) 225 and the exhaust vents 226 can be located away from each other, such as in opposite portions of the panel 220, to encourage air flow through the entire panel. For example, in some configurations, one or more air intake vent 225 is located on a bottom portion of the rear access panel 222, and the exhaust vents 226 are located on a top portion of the rear access panel 222. In other configurations, the exhaust vents 226 are located on a bottom portion of the rear access panel 222, and the intake vent 225 is located on a bottom portion of the rear access panel 222.

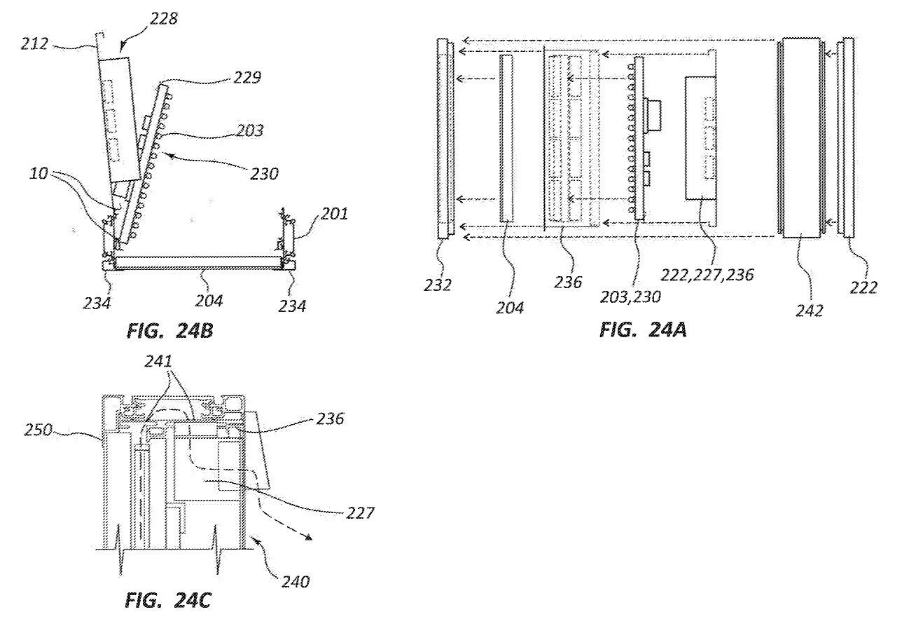

FIG. 24 includes a top sectional view of an embodiment of the cabinet 220. As depicted in the top sectional view, a cabinet 220 can comprise an enclosure housing 201 having a chassis body 228 that selectively opens by a door 212 that is connected to the enclosure housing 201 via a hinge point of a hinge assembly 210. In some configurations, as a shown, the door comprises a portion of the rear access panel 222 and opens rearward, such that a person working on the display stands behind the display to access its internal components. In some configurations, a fan assembly is also hingedly coupled to the enclosure housing 201 via a hinge assembly 210, such that it can be opened in order to gain access to internal components of the cabinet 220. In some embodiments, the fan assembly 227 is coupled to the rear access panel 222 such that it moves with the rear access panel 222. In other embodiments, the fan assembly 227 and the rear access panel comprise separate components, each individually hinged to the enclosure housing 201.

Additionally, in some instances, one or more internal components of the cabinet 220 are also connected via a hinge point of the hinge assembly 210, so that these components can be selectively removed, in a layer-by-layer fashion. For example, in some embodiments, a lamp assembly panel 203 and associated lamp assembly electrical components are disposed on a panel that is hingedly coupled to the enclosure housing 201. Accordingly, a user can access the lamp assembly 203 and electric components 230 as well as to an LCD display 204 by pivoting the panel at its hinge point, thus gaining access to interior elements of the enclosure 201. Furthermore, in some instances, the LCD display is also coupled to the enclosure housing 201 via the hinge assembly 210.

The top view assembly shown in FIG. 24 illustrates the relationship of the constitutive elements of an enclosed housing 201 utilized in the cabinet 220 in accordance with some embodiments. As shown, a cabinet 220 can comprise a front door retainer 232. In some embodiments, the front door retainer has a rectangular-frame shape, as shown in FIG. 23. The shape of the opening in the rectangular-frame-shaped retainer 232 can be approximately equal to the shape of the display screen of the LCD display 204.

A front door retainer 232 can allow access to the LCD display unit 204 without having to access the LCD display unit 204 through the rear access panel 222. In some embodiments, the front door retainer 232 additionally allows for a replacement LCD display to be mounted within the same outdoor LCD menu cabinet 220 such that as new LCD technology is developed, or if different sized LCD displays 204 are desired for use in a menu display cabinet 220, the menu display cabinet 220 can be retrofitted effectively with a new LCD display unit 4 without having to replace the other constitutive elements of the LCD menu display cabinet 220.

In some configurations, the front door retainer 232 comprises frame brackets 234 affixed to either side of an LCD display unit. The frame brackets 34 can be structured for coupling to the cabinet. The frame brackets 234 can be coupled to a hinge that opens and close the front door retainer 232, such that the front door 232 can be swung open in a door-like fashion, leaving one of the framed brackets hingedly coupled to the chassis body 236 or cabinet body 242. As shown, in some configurations, the frame bracket 234 is a hollow member having a bracket extension 250 that extends perpendicularly from the frame bracket 234 to the interior of the cabinet 220. This bracket extension 250 can provide lateral support to the LCD display 204 that can prevent the LCD display 204 from falling out the front of the cabinet 220. In some embodiments, the frame bracket includes walls disposed at right angles to each other, and an interior wall that abuts a LCD display 204 and supports the display within the cabinet 234.

As depicted in the top view assembly of FIG. 24, the LCD display 204 can be affixed to the front door retaining unit 232 to allow visualization of advertisement and/or menus through the front door retaining unit 232. Fixed to the front door retaining unit 232, the LCD display 204 can hingedly be attached to the chassis body 236, such that the LCD display can be accessed from a front side of the display. In other instances, the LCD display 204 is not affixed to the front door retaining unit 232, but rather statically or hingedly coupled to the cabinet 220.

In some embodiments, the LCD display 204 can be bonded to IR and AR glass. LCD display devices in exterior environments face difficulty under ambient light and heat. Heating of the LCD panel either by the various constitutive electronic units interior the cabinet or by direct sunlight causes clearing, in which the LCD screen goes black. Clearing can be avoided by bonding IR and/or AR glass to the exterior surface of the LCD display, as well as by utilizing a cabinet cooling system 205. Reducing radiant heat absorbed by the LCD display 204 by effective removal of hot air from the interior of the cabinet body 228 can be desired.

In addition to the user of IR/AR glass, the LCD display can be utilized as an effective medium both during nighttime and during daytime conditions for displaying various advertisements or promotional items, particularly in outdoor environments when one or more cooling systems are utilized. As illustrated in FIG. 24, the air flow supply system 240 can cool the cabinet by channeling air through an air channel 211 that passes through the interior elements of the display cabinet 220. The air flow supply system 240 can allow for free flowing air, or forced air, to move through the interior body and around the constitutive elements of the display cabinet 220. Embodiments of an air flow supply system 240 can comprise a fan assembly 227, an air channel 211, intake vents 225, and/or exhaust vents 226.

In some configurations, one or more air channels 211 are disposed between the lamp assembly panel 230 and the LCD display 204 and/or the rear door retainer 22. For instances, one or more air channel, such as a gap, channel, or series of channels, is disposed between the lamp assembly panel 230 and the LCD display 204. In some embodiments, this air channel includes a gap between the components of the lamp assembly panel 230 and the LCD display 204. In some embodiments, this gap is at least 3 mm in width. In other embodiments, this gap ranges between 1 mm and 1 cm. As shown in FIG. 24, this air channel can be in fluid communication with the fan assembly 227 so that air can be circulated between these two components.

In some embodiments, a fan assembly 227 can be fixed at a point near the rear air intake vents 225 and/or near the rear air exhaust vents 226. Slots 241 can be provided and located for air flow along the chassis body 236, allowing air flow to move not only between the various constitutive elements of the display cabinet 230, but through the chassis body 236 of the outdoor LCD menu display cabinet 220 as well. In some embodiments, these slots 241 are located in the top and bottom of the chassis body 236. In other embodiments, these slots are located in the top and bottom as well as through the middle of the chassis body 236. In particular, slots 241 can be formed through the interior portion of the chassis body 236 that support the sides (as opposed to the front or back) of the internal components (including the lamp assembly 230 and LCD display 204).

To further facilitate air flow through the cabinet, one or more air channels 211 can be disposed between top, bottom, and or sides of the lamp assembly panel 230 and/or the LCD display 204. In some embodiments, this air channel 211 is a gap, while in other embodiments, this air flow channel is a hole or set of holes.

In some configurations, slots 241 are positioned so as to be between the LCD display and the lamp assembly 230, between the lamp assembly 230 and the rear door retainer 422, and/or at both of these locations, as show in FIG. 24. Furthermore, as also shown in FIG. 24, in some embodiments, the chassis body 236 includes a hollow portion that forms an air channel 211 between two or more slots 241 within the chassis body 236 to enable airflow therethrough. In some instances, the two or more slots 241 are located at approximately the same height on the chassis body 236, while in other embodiments, these slots 241 are located at difference heights. Still, in other embodiments, a large number of slots 241 (e.g. ten or more) are disposed at various heights along the chassis body 236 forming various air channels 211 therethrough.

As depicted in FIG. 24, the chassis body 236 can be coupled to a rear access panel 222 having a fan assembly 227. The fan assembly 227 can comprise a plurality of cooling fans 227. In some embodiments, only one fan can be utilized. In other embodiments two, three, four, five, or more fan units can be utilized in order to accommodate and provide requisite air flow through the display cabinet 220. In some embodiments, one or more fans are located at approximately the same height on the chassis body 236 a slot 241 between the lamp assembly 230 and the rear door retainer 422, in order to introduce air flow therethrough. In some embodiments, the fans blow air into the cabinet 220, whine in other embodiments, the fans suck air out of the cabinet 220. In some embodiments, one or more fans blow air into the cabinet 220 while one or more other fans suck air out of the cabinet 220.

Exterior to a chassis body 236, embodiments can provide a cabinet body or housing 242. The cabinet body 242 can be constructed of various materials and provide support for both chassis body 236 and other elements of the display cabinet 220 contained therein. Providing for attachment of the chassis body 36 to the cabinet body 242 can allow the rear door retaining element 222 and front door retaining element 232 to be effectively coupled, hingedly or otherwise, to the cabinet display body 242.

FIG. 24 also depicts a gasket seal 250 that seals the opening of the fan assembly 227. Furthermore, in some embodiments, one or more other openings in the cabinet 220 can include a gasket seal that provides a water-tight seal to the cabinet to protect the cabinet from water and other environmental conditions.

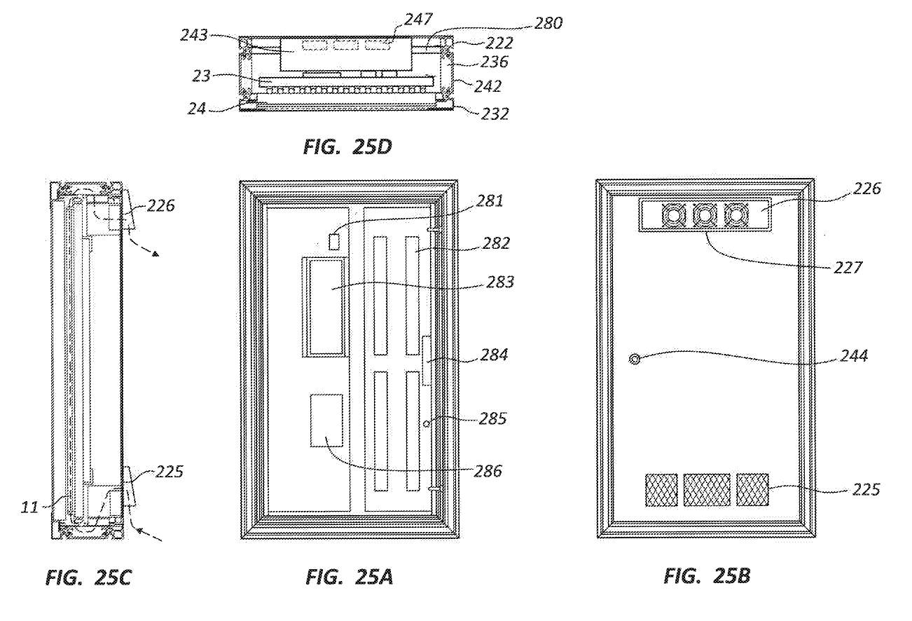

FIG. 25 depicts a sectional view of a display cabinet 220 at the cabinet's center. Embodiments can comprise an air intake vent 225, an air channel 211 and air exhaust vent 226 to allow free passage of air through the cabinet to provide for cooling of the various elements contained within the cabinet body, allowing for temperature control of the interior elements of the cabinet body. Maintaining control over the temperature of the interior cabinet the interior of the cabinet can effectively increase longevity of mechanical units contained on the interior of the cabinet as well as increase the probability that an LCD display unit 204 will provide adequate visual display, even under direct sunlight. The cooling system 205 of the cabinet can be coupled to one or more fans 227 to force air through the channel system 211 from the air intake vent 225 to the air exhaust vent 226. In some instances, the cooling system can force air in from the bottom of the cabinet 220 and out through the top of the cabinet in order to remove hot air that tends toward the top of the cabinet. In some embodiments, an air filter may be provided at the air intake vents to decrease the flow of contaminants into the body of the cabinet 270.

FIG. 25 also provides a top sectional view of an embodiment of a display cabinet 220 comprising a front door retaining unit 232, wherein the front door retaining unit 232 utilizes at least two frame brackets 234 for fixing the front door retaining unit 232 to the chassis body 236. The front door retaining unit 232 may provide for coupling to a cabinet body 242. Hingedly connecting the front door retaining unit to the cabinet body 242 may allow the components internal the front door retaining unit 232 to be exposed when necessary, while maintaining a connection to the cabinet body 242. Providing a connection between the LCD display 204 to the front door retainer 232 allows the incorporation of various LCD display units to a display cabinet 220.

Furthermore, from this top sectional view, it can be seen that in some configurations, the cabinet includes large open spaces 280 between the lamp assembly 203 and the rear door 222 to facilitate air flow there between. Furthermore, this view illustrates the need for slots 241 through the chassis body 236 to provide for a fluid path 211 between the front and rear portions of the lamp assembly 203.

A lamp assembly 203 can be utilized in conjunction with the LCD display unit 204 providing backlighting or lighting to other display features surrounding the LCD display unit, enhancing both the capacity of the menu display cabinet to provide information as well as to increase the aesthetic value of the cabinet body itself 242. In some embodiments, an independent chassis body 243 can be utilized to house a fan assembly 247. The independent chassis body 243 can be fixedly or hingedly attached to a rear access panel 222. Similar to the construction of the front retaining door 232, the rear door retaining unit 222 can utilize frame brackets 234 designed to hingedly affix the independent chassis body 43 and affixed rear door retaining unit 222 to the cabinet body 228 and/or the chassis body 236. Hinged attachment of the rear door retaining unit 222 to the chassis body 236 and/or the cabinet body 228 allows the constitutive elements coupled to the rear retaining unit 222 to be hingedly opened and accessed for mechanical upkeep and/or replacement.

Further depicted in FIG. 25 is a rear view of a chassis door panel in accordance with an embodiment of the invention. The chassis door panel 243 can comprise air intake vents 225, air exhaust vents 226, a fan assembly 227 and a lock 244. Use of a lock or latch on the chassis door panel 243 allow for periodic opening of the chassis door back panel. As depicted, the cabinet cooling system 205 can comprise one or more cooling fans. As depicted in FIG. 25, three cooling fans can be utilized, but in other embodiments, five or more cooling fans can be utilized, and in other embodiments, one fan can be utilized to force air through the air intake vents 235 to air channels 211 and out through the air exhaust vents 226.

FIG. 25 further depicts specific details of the electrical components 230 on a lamp assembly panel 203, according to one embodiment. As shown, in some embodiments, the electrical components 230 include a thermostat control, a ballast, a power supply (e.g. a 120 V ac/12 V DC power supply), a row terminal block (e.g a dual row terminal block), a power disconnect, and a video control board. In some embodiments, the thermostat control is disposed on the top of the lamp assembly panel 203.

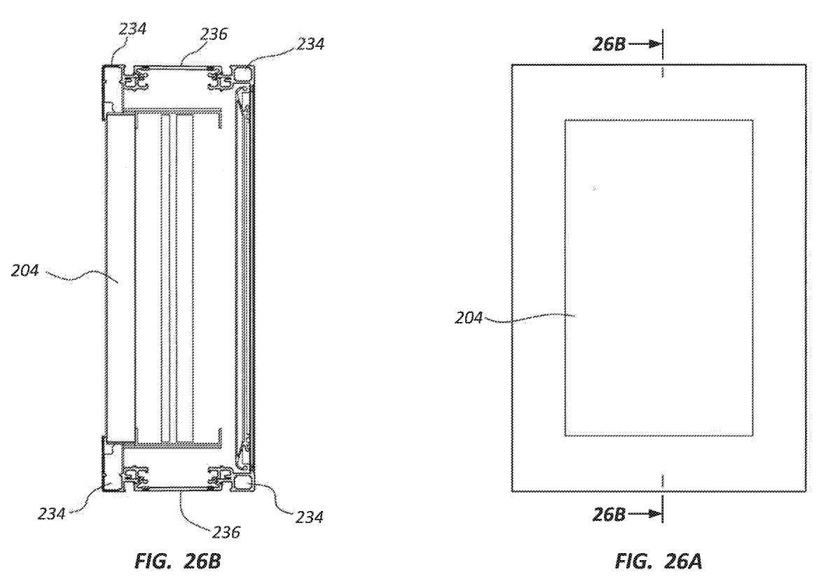

FIG. 26 provides both a front view and a top cutaway view of various elements of display cabinet 220, including an LCD panel 4 bonded to IR and/or AR glass coupled to frame brackets 234. The frame brackets 34, as depicted, can be hingedly attached to a chassis body 36. The chassis body 236, front door retaining units 221, rear door retaining units 222 and frame brackets 234 are all preferably made from aluminum extruded in a cross sectional shape shown in the drawings. It is understood that the frame sections could also be made in other configurations and from other materials, such as suitable plastic materials.

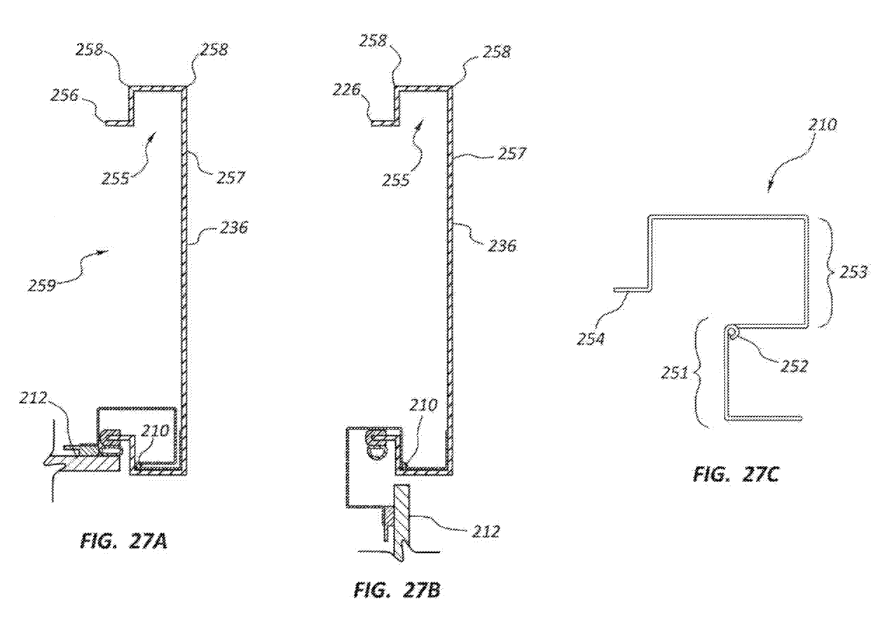

FIG. 27 illustrates an embodiment of a hinge assembly 210 within a chassis body 236 in a closed and open position. The depicted hinge assembly can be made of various elements or manufactured out of any desired metal, plastic or carbon fibered product. In order to prevent the doors from being improperly removed, hinged members 245 can be formed into the configurations shown so they can only be assembled and dissembled by authorized personnel. As illustrated, the hinged members 242 can be couple the frame bracket 234, the front retaining unit 232 and/or the rear access panel 222 to the chassis body 236 and/or the cabinet body 242 of a display cabinet 220.

Specifically, the hinge assembly 210 is formed of a L-shaped member 251, a pivot member 252, and a swinging member 253. The L-shaped member 251 is substantially L-shaped and is coupled to the chassis body 236. The pivot member 252 is disposed at an end of the L-shaped member at enables the swinging member 253 to pivot about the pivot member 252. The swinging member 253 can be configures as shown in FIG. 27, having four right-angle bends that form an incomplete rectangle. The swinging member 253 can be coupled to a panel, door, LCD display, or other component via the swinging member extension 254, which extends outwardly from the swinging member. The hinge assembly 210 of FIG. 27 allows the pivot member 252 to be dispose within a recess 255 of the chassis body 236, which can provide structural support.

FIG. 27 also illustrates a cross-sectional view of a chassis body 236 according to some embodiments. As shown, the chassis body 236 can have a substantially C-shape with two body extensions 256 directed inwardly. In some embodiment, the chassis body is formed of substantially right angles. The chassis body 236 includes a straight portion 257 that defines the depth of the chassis body. At each end of the straight portion 257, the chassis body 236 has two right-angle bends 258 that form a recess 256. Thus configured, the chassis body 236 forms a pocket 259 between the two body extensions 256 and the recesses 256. The components of the cabinet 220 can be coupled within the pocket 259. This configuration can provide strength and functionality to the display cabinet 220.

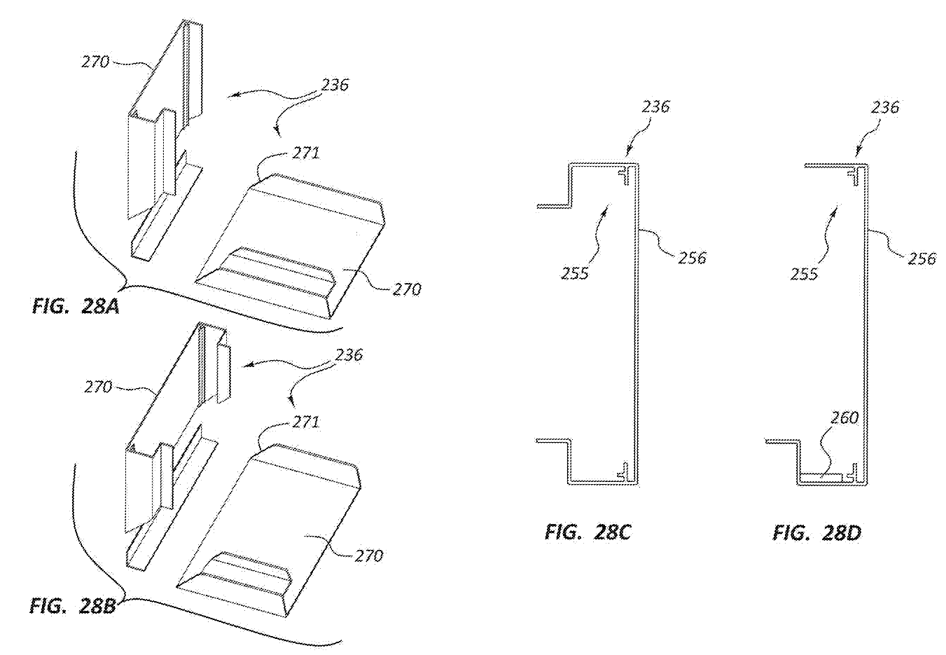

FIG. 28 illustrates both a double face cabinet and a single face cabinet according to various embodiments of the invention. Each face is comprised of the sides forming the recess 256 as well as the body extension 256. In some embodiments, the chassis body 236 includes only a recess, thus forming a single face cabinet, as shown. Furthermore, in some embodiments, the chassis body 236 includes an inward extension 260 or 261 disposed parallel to the straight portion 257. This inward extension can be linear or T-shaped as shown.

FIG. 28 further illustrates the junction of two sides of the chassis body 236 to form a corner of the chassis body 236. As shown, in some configurations, two sides of the chassis body 270 are cut at an angle (e.g. approximately a forty-five degree angle) to form an angled portion 271. The cut portions 270 are coupled together along the angles portion 271. A corner member (comprised of an L-shaped portion of material) receives the two sides of the chassis body 270 and supports the junction. In some embodiments, the two sides 271 are welded together. In other embodiments, the two sides 271 are coupled together with a brad, screw, or other such fastener. In some embodiments, the chassis body 236 is formed of extruded aluminum material.

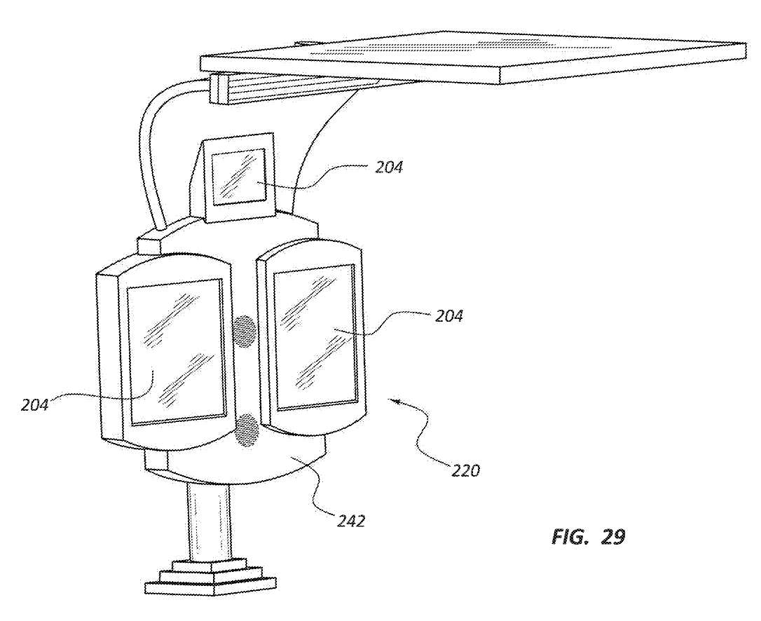

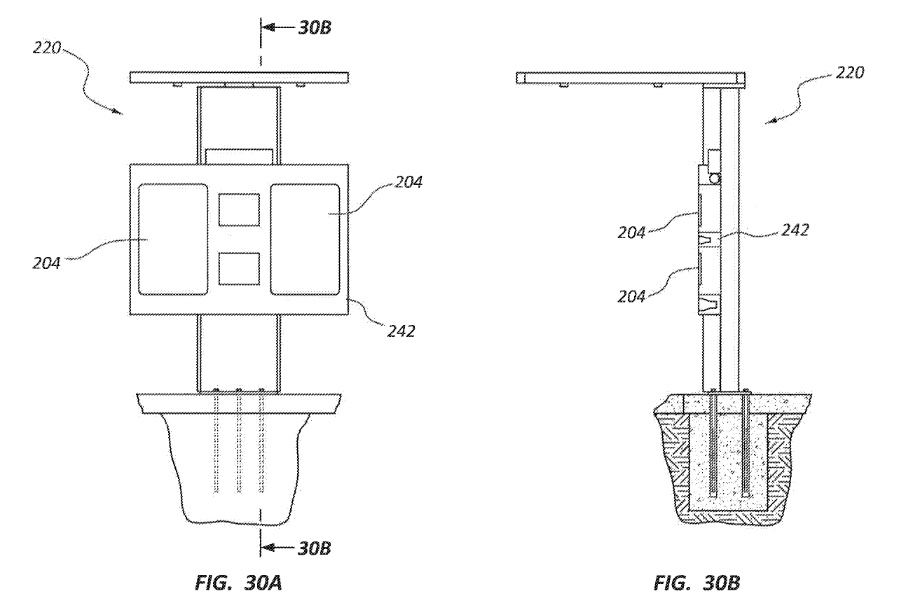

FIGS. 29 and 30 illustrate exterior cabinets 220 with multiple LCD screens 204 according to some embodiments.

The present invention can be embodied in other specific forms without departing from its spirit or essential characteristics. The described embodiments are to be considered in all respects only as illustrative and not restrictive. The scope of the invention is, therefore, indicated by the appended claims, rather than by the foregoing description. All changes which come within the meaning and range of equivalency of the claims are to be embraced within their scope.

What is claimed is:

1. A display cabinet system comprising:
a lamp assembly hingedly attached to a chassis body contained within a cabinet body;
an LCD display unit coupled to the chassis body; and
a cabinet cooling system comprising air intake vents, air exhaust vents and air channels throughout the interior of the display cabinet, one of the air channel being between the LCD display unit and the lamp assembly.

2. The display cabinet of claim 1, wherein the chassis body comprises slots accommodating the flow of air through the chassis body.

3. The display cabinet of claim 2, wherein at least one of the slots is between the LCD display unit and the lamp assembly, and wherein another of the slots is between the lamp assembly and a rear access panel.

4. The display cabinet of claim 1, wherein the LCD display is hingedly attached to the chassis body.

5. The display cabinet of claim 1, wherein the LCD display is attached to a front display side.

6. The display cabinet of claim 1, further comprising a rear access panel.

7. The display cabinet of claim 1, further comprising at least one cooling fan.

8. The display cabinet of claim 1, wherein the LCD display includes IR glass or AR glass bonded thereto.

9. The display cabinet of claim 1, further comprising a thermostat control device.

10. The display cabinet of claim 1, further comprising a power supply.

11. The display cabinet of claim 1, further comprising a video control board.
